(19) United States
(12) Patent Application Publication
(10) Pub. No.: US 2005/0255827 A1
(43) Pub. Date: Nov. 17, 2005

(54) Method and system for construction and communication of data on network access and service transactions in a telecommunication network

(76) Inventors: Gerry Foster, Swindon (GB); Farah Khan, Swindon (GB)

Correspondence Address: MOTOROLA, INC., 1303 EAST ALGONQUIN ROAD, IL01/3RD, SCHAUMBURG, IL, 60196, US

(21) Appl. No.: 10/505,823

(22) PCT Filed: Mar. 17, 2003
(86) PCT No.: PCT/EP03/02751

§ 371 Date: Aug. 26, 2004

(30) Foreign Application Priority Data
Mar. 26, 2002 (GB) 0207088.6

(51) Int. Cl. H04M 11/00

(52) U.S. Cl. 455/406; 455/407

(57) ABSTRACT

A method for construction and communication of data for charging and billing for network access and service transactions, which comprises the step of generating (100) a Charging Data Record (CDR) for each connection of a User Equipment (UE) a telecomunication network. Service providing servers accessed by the UE generate in two steps Event Detail Records (EDRs): first step (104) is tagging each event caused by a user of said UE, second step (106) is assigning transaction ID and transaction details to said tag. Further the CDR and the EDR are collated (108) with the tags to create a Session Detail Record (SDR). The SDR is sent (118) to a mediation and routing engine. The mediation and routing engine processes (120) the SDR to the required format. Then the SDR is forwarded (122) to a rating engine, which expands (124) said tags, calculates and adds charges (126). Then said SDR is forwarded (128) to a billing server for generating (130) a unified bill and finally the unified bill is sent (132) to the user of the UE.

### TECHNICAL FIELD

The present invention relates to telecommunication systems, and in particular to a method and a system for construction and communication of data on network access and service transactions in a telecommunication network to provide charging and billing in said telecommunication network. The invention is applicable to, but not limited to, wireless communication systems such us third generation packet data and communication networks.

### BACKGROUND

With the advent of the third generation mobile technology, the end-user will be able to access various types of services over their mobile phones through the use of the multi-service IP network. Therefore the options for charging extend further than charging only for mobile access to the network to charging for content as well. Examples of such content to be charged could be services like e-mail or e-commerce transactions carried out during a session.

However, an Internet Protocol (IP) network has a heterogeneous infrastructure comprising of a wide range of technologies and vendors. The result of this situation is that each network element and service provider are likely to capture the charging data independently, as the usage parameters for each kind of service are usually distinct from each other. This leads to many disparate approaches to charging which is expensive to manage, administer and deploy.

The systems presently available are proprietary billing systems which have no standard interfaces in place to exchange usage, provisioning and control information, therefore there is no unified bill generated for the end-user. Even the standards have enshrined the historical evolution of separate systems for contract billing (Call and Event data) and prepaid charging (CAMEL).

Moreover these proprietary systems do not have a standard format of Charging Data Record (CDR), which ultimately hinders the operation of IP network elements and support systems to be able to communicate cost-effectively. Presently there are various CDRs generated within a network for each individual event caused by the user. Sometimes some events are missed out because of lack of collation of CDR for the individual user. In some cases there is no way to identify which user accessed which service because in the end it is all data or packets which are going through the network. This creates a barrier to bringing next generation services to the market.

### SUMMARY OF THE INVENTION

There is a need for a method and a system for construction and communication of data on network access and service transactions in a telecommunication network to provide charging and billing in said telecommunication network, which alleviate or overcome the disadvantages of the prior art.

The method and the system according to the present invention make possible to unite billing and charging into a common framework. Result is one system presentation for end-user delivered by the third generation packet data networks for both the user equipment (i.e. wire and wireless communication devices, Portable Digital Assistants (PDA), laptop, desktop and palmtop computers) and the network.

A method for construction and communication of data on network access and service transactions in a telecommunication network to provide charging and billing in said telecommunication network, said method comprising the following steps: (a) generating a Charging Data Record (CDR) for each connection of a User Equipment (UE) to said telecommunication network, (b) generating an Event Detail Record (EDR) in two substeps: (b1) tagging each event caused by a user of said UE during said connection, (b2) assigning transaction ID and transaction details to said tag used for tagging said event in previous step, wherein said transaction details being retrieved from a network equipment, (c) collating said CDR and EDR with said tags to obtain a Session Detail Record (SDR), (d) sending said SDR to a mediation and routing engine, (e) forwarding said SDR to a rating engine, (f) forwarding said SDR to a billing server for generating a unified bill, (g) sending said unified bill to said UE user.

The mediation and routing engine processes the SDR to meet the format required by additional network management systems. The additional network management systems are: fraud management, data warehousing and security systems.

The rating engine expands said tags with the transaction details, then calculates and adds charges depending on type of said transaction.

When transaction requires credit authorization and authentication the SDR is sent to a monetary authorization server.

An advantage of the present invention is that it makes possible to gather data on transmission independently on the service provider and network element involved in the transmission.

Another advantage of the present invention is that the method is easy to manage and deploy because it provides a standard interface for provisioning and control information what results in unified bill generated for the end user. Additionally one type of generated CDR within a telecommunication network makes it possible to increase effectivenes of network components.

Another advantage of the invention is that it allows identifying, which user accessed, which service before finally generating a reliable bill.

In accordance with another aspect of the present invention, there is provided a system for carrying out the method according to the present invention as described above.

The system in accordance with the present invention has a network node for generating a Charging Data Record (CDR) for each connection of said UE to said telecommunication network. Each network element is equipped with a tagging function for tagging each event caused by the user of said UE during said connection. The system also comprises a service providing server for generating an Event Detail Record (EDR) and a Charging Gateway Functionality (CGF) for collating said CDRs and EDRs with said tags to generate a Session Detail Record (SDR). A mediation and a routing engine of the system is for processing of said SDR into a format compatible with format acceptable by a rating engine which is designed for expanding said tags and calculating and adding charges. The system also comprises a billing server for generating a unified bill, for said UE user.

The system according to the present invention may have rating, billing and monetary authorization servers aggregated into one or more separate devices.

### BRIEF DESCRIPTION OF THE DRAWINGS

The present invention will be understood and appreciated more fully from the following detailed description taken in conjunction with the drawings in which:

FIG. 1 is a flowchart illustrating a method for charging and billing for network access and service transactions in accordance with an embodiment of the invention;

FIG. 2 is a schematic illustration of a system for charging and billing for network access and service transactions in accordance with an embodiment of the invention.

### DETAILED DESCRIPTION OF THE PREFERRED EMBODIMENT

The term User Equipment (UE) herein below is a general term that includes wire and wireless communication devices, Portable Digital Assistants (PDA), laptop, desktop and palmtop computers.

The term Event Detail Record (EDR) herein below is a general term used to denote event characteristics, for any activity that can be monitored and therefore is accountable.

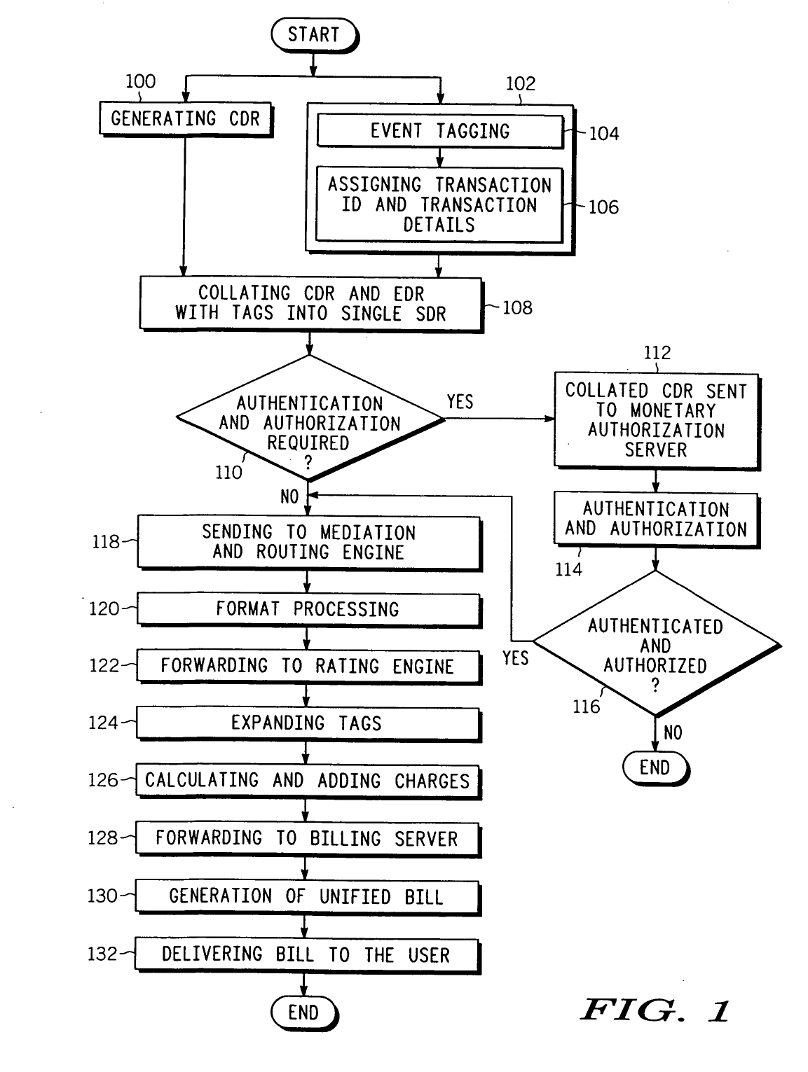

Referring to FIG. 1, in step 100 for each connection of a User Equipment to said telecommunication network a Charging Data Record (CDR) is generated. The CDR is generated by a network node. Independently service providing servers accessed by the UE generate in step 102 Event Detail Records (EDRs). Generation of said EDRs is performed in two substeps. In substep 104 each event caused by a user of said UE during said connection is tagged and in step 106 transaction ID and transaction details are assigned to said tag used for tagging said event in previous substep. Said transaction details being retrieved from a network equipment. In step 108 the CDR and EDR are collated with the tags to form a single Session Detail Record (SDR). In the following step, 118, said SDR is sent to a mediation and routing engine. Said mediation and routing engine processes in step 120 said SDR into a format acceptable by a billing server, a rating engine and other network management systems. After processing 120 the mediation and routing engine delivers in step 122 said SDR to said network management systems and said rating engine. The rating engine expands 124 said tags with said transaction details and calculates and adds in step 126 charges according to type of said transaction. In the next step, 128, said SDR is forwarded 128 to said billing server for generating 130 a unified bill. In the final step, 132, said unified bill is delivered to said UE user.

Further aspects, variations and details of the invention are described in the following.

When the transaction requires authentication and authorization 110, said SDR is sent 112 to a monetary authorization server. Depending on result of said authentication and authorization 114 the process is stopped if authentication or authorization failed. When authentication and authorization passed, the SDR is sent to a mediation and routing engine in step 118.

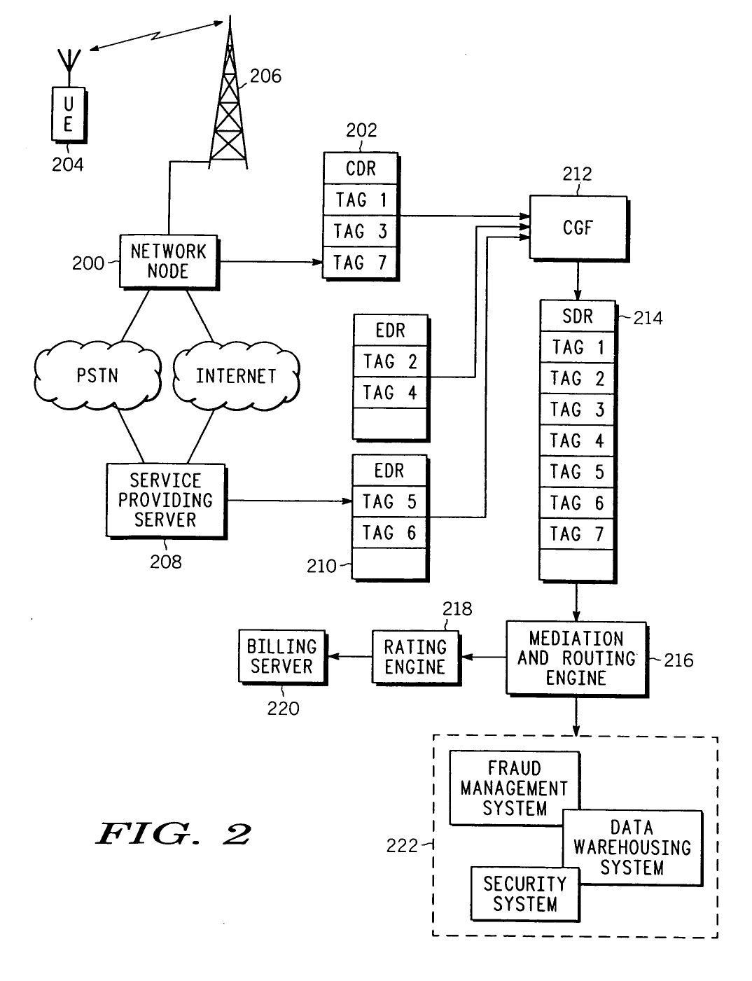

Reference is now made to FIG. 2, which depicts a system for construction and communication of data on network access and service transactions in a telecommunication network to provide charging and billing in said telecommunication network operative in accordance with the embodiment of the present invention as illustrated on FIG. 1.

The system according to present invention has a network node 200 for generating a CDR 202. CDR 202 is generated for each connection of a UE 204 to said telecommunication network 206. Each network element is equipped with a tagging function for tagging each event caused by the user of said UE 204 during said connection. The system also comprises a service providing server 208 for generating an Event Detail Record (EDR) 210.

Depending on type of service accessed by the user the service providing server 208 may be a content server, e-commerce server or server providing other kind of services.

The system further comprising a Charging Gateway Functionality (CGF) 212 for collating said CDRs 202 and EDRs 210 with said tags to generate a Session Detail Record (SDR) 214.

It is also important to note that a session in the SDR means user session and all the services used by the user will be a subset of the user session. This causes that the SDR is a single consolidated form giving details of user activity for the entire duration of user connection to the telecommunication network.

In alternative embodiments the CGF 212 can be incorporated with either the network node 200 or mediation and routing engine or can be a separate physical device on its own.

A mediation and a routing engine 216 of the system are for processing of said SDR 214 into a format compatible with format acceptable by a rating engine 218 which is designed for expanding said tags and calculating and adding charges. The system also comprises a billing server 220 for generating a unified bill, for said UE 204 user.

In different embodiments the network node for generating CDRs may be a GPRS Serving Node, a Mobile Switching Centre, a Switch or other network element.

In another embodiment the system comprises monetary authorization server, which is contacted when a transaction, which was done during said connection requires credit authentication and authorization.

In yet another alternative embodiments the rating, billing and monetary authorization servers are aggregated in any combination as one, two or three separate devices.

In another embodiment the mediation and routing engine 216 is connected to additional network systems 222 such as fraud management system, data warehousing system and security system.

In general the fraud management system is a peripheral system, which analysis the data in CDRs to identify the users who are attempting some fraud by not using the network properly. The data warehousing system is system, which stores all the data for future reference to answer customer complains or to make other subscription related changes. Security system maintains the security of passwords and other sensitive data passing over the network.

It will be understood that the invention tends to provide the following advantages singly or in any combination:
possibility of gathering data on transmission independently on the service provider and network element involved in the transmission,
the method is easy to manage and deploy,
unified bill generated for the end user,
one type of generated CDR within a telecommunication network makes it possible to increase effectivenes of network components,
the method allows identifying which user accessed which service, what results in generating a reliable bill.

1. A method for construction and communication of data on network access and service transactions in a telecommunication network to provide charging and billing in said telecommunication network, said method comprising the following steps:
(a) generating (100) a Charging Data Record for each connection of a User Equipment to said telecommunication network,
(b) generating (102) an Event Detail Record in two substeps:
(b1) tagging (104) each event caused by a user of said UE during said connection,
(b2) assigning (106) transaction ID and transaction details to said tag used for tagging said event in previous step, wherein said transaction details being retrieved from a network equipment,
(c) collating (108) said Charging Data Record and Event Detail Record with said tags to obtain a Session Detail Record,
(d) sending (118) said Session Detail Record to a mediation and routing engine,
(e) forwarding (122) said Session Detail Record to a rating engine,
(f) forwarding (128) said Session Detail Record to a billing server for generating (130) a unified bill,
(g) sending (132) said unified bill to said User Equipment user.

2. A method according to claim 1 wherein said mediation and routing engine processes (120) said Session Detail Record into a format compatible with format acceptable by said rating engine, said billing server and additional network management systems and delivers (122) said Session Detail Record to said network management systems and said rating engine.

3. A method according to claim 2 wherein said additional network management systems are fraud management system, data warehousing system and security system.

4. A method according to claim 1 wherein said rating engine expands (124) said tags with said transaction details and calculates and adds (126) charges according to type of said transaction.

5. A method according to claim 1 wherein SDR is sent (112) to a monetary authorization server when said transaction requires credit authentication and authorization (116).

6. A system for carrying out the method according to claim 1, said system comprising the following components:
a network node (200) for generating a Charging Detail Record (202), for each connection of User Equipment (204) to said telecommunication network (206),
a tagging function at each network element and service providing servers for tagging each event caused by the user of said User Equipment (204) during said connection,
a service providing server (208) for generating an Event Detail Record (210),
a Charging Gateway Functionality (212) for collating said Charging Data Record (202) and Event Detail Record (210) with said tags to generate a Session Detail Record (214) and for sending said Session Detail Record (214) to a mediation and routing engine (216),
said mediation and routing engine (216) for processing of said Session Detail Record (214) into a format compatible with format acceptable by a rating engine (218),
said rating engine (218) for expanding said tags and calculating and adding charges,
a billing server (220) for generating a unified bill, for said User Equipment (204) user.

7. A system according to claim 6 wherein said network node is a GPRS Serving Node, a Mobile Switching Centre, a Switch or other network element.

8. A system according to claim 6 wherein said system further comprising monetary authorization server.

9. A system according to claim 8 wherein said rating, billing and monetary authorization servers are aggregated into one or more separate devices.
